(19) United States
(12) Patent Application Publication
(10) Pub. No.: US 2002/0123900 A1
(43) Pub. Date: Sep. 5, 2002

(54) Method for setting on-line commerce web site

(76) Inventor: Chen Shi Yang, His Chin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/797,584

(22) Filed: Mar. 5, 2001

(51) Int. Cl. G06F 17/60

(52) U.S. Cl. 705/1

(57) ABSTRACT

A method for setting on-line commerce Web site is proposed, wherein a business Web site is set up in a computer server of a company using the method. The company uses the Web site to deal commerce with a provider or a customer through Internet. The Web site comprises a company profile setting and a code setting to facilitate a system engineer to update and maintain the company data, product data and trade-related terms.

### FIELD OF THE INVENTION

The present invention relates to a method for setting on-line commerce Web site, especially to a method for setting on-line commerce Web site, which setting the company profile and trade-related codes.

### BACKGROUND OF THE INVENTION

The e-commerce become more and more attractive as the Internet is popular over the world. Therefore, the set up and maintenance of Web site are important issues to ensure and facilitate the e-commerce for business such that the business can smoothly deal business with provider and customers. The front page is especially important for the Web site of the company to display trade and contact approach and trade-related items.

### SUMMARY OF THE INVENTION

It is the object of the present invention to provide a method for setting on-line commerce Web site, which setting the company profile and trade-related codes.

To achieve above object, the present invention provides a method for setting on-line commerce Web site. The business Web site is set up in a computer server of a company using the method. The Web site comprises a company profile setting and a trade-related code setting to facilitate a system engineer to update and maintain the company data, product data and trade-related terms. The text or picture linked to the items of the company profile is clicked and the sub page for above item is displayed. Afterward, the system engineer updates the content of this page and the updated data is saved in the database of the server to finish the maintenance for data of this page. To update the items of code setting, the menu of the items are pulled down, and new contents is added to update the items.

The various objects and advantages of the present invention will be more readily understood from the following detailed description when read in conjunction with the appended drawing, in which:

### BRIEF DESCRIPTION OF DRAWING

FIG. 1 shows the schematic diagram of the present invention for dealing commerce in Internet;

FIG. 2 shows the functional block of the present invention;

FIG. 3 shows the block diagram of the company profile setting;

FIG. 4A shows the flowchart for maintaining the page of the quote from president;

FIG. 4B shows the flowchart for maintaining the page of the vision;

FIG. 4C shows the flowchart for maintaining the page of the business;

FIG. 4D shows the flowchart for maintaining the page of the history;

FIG. 4E shows the flowchart for maintaining the page of the contact us;

FIG. 4F shows the flowchart for maintaining the page of the benefits of joining us;

FIG. 4G shows the flowchart for maintaining the page of the product and service;

FIG. 4H shows the flowchart for maintaining the page of the our customer;

FIG. 4I shows the flowchart for maintaining the page of the enterprises group;

FIG. 4J shows the flowchart for maintaining the page of the partners;

FIG. 5 shows the block diagram of the code setting;

FIG. 6A shows the flowchart for setting the country;

FIG. 6B shows the flowchart for setting the trust grade;

FIG. 6C shows the flowchart for setting the title;

FIG. 6D shows the flowchart for setting the education type;

FIG. 6E shows the flowchart for setting the business type;

FIG. 6F shows the flowchart for setting the bulletin type;

FIG. 6G shows the flowchart for setting the product category;

FIG. 6H shows the flowchart for setting the product unit;

FIG. 6I shows the flowchart for setting the tax rate;

FIG. 6J shows the flowchart for setting the credit card type;

FIG. 6K shows the flowchart for setting the trading type;

FIG. 6L shows the flowchart for setting the pay term;

FIG. 6M shows the flowchart for setting the trading type;

FIG. 6N shows the flowchart for setting the pay method;

FIG. 6O shows the flowchart for setting the trade term;

FIG. 6P shows the flowchart for setting the delivery term.

### DETAILED DESCRIPTION OF THE INVENTION

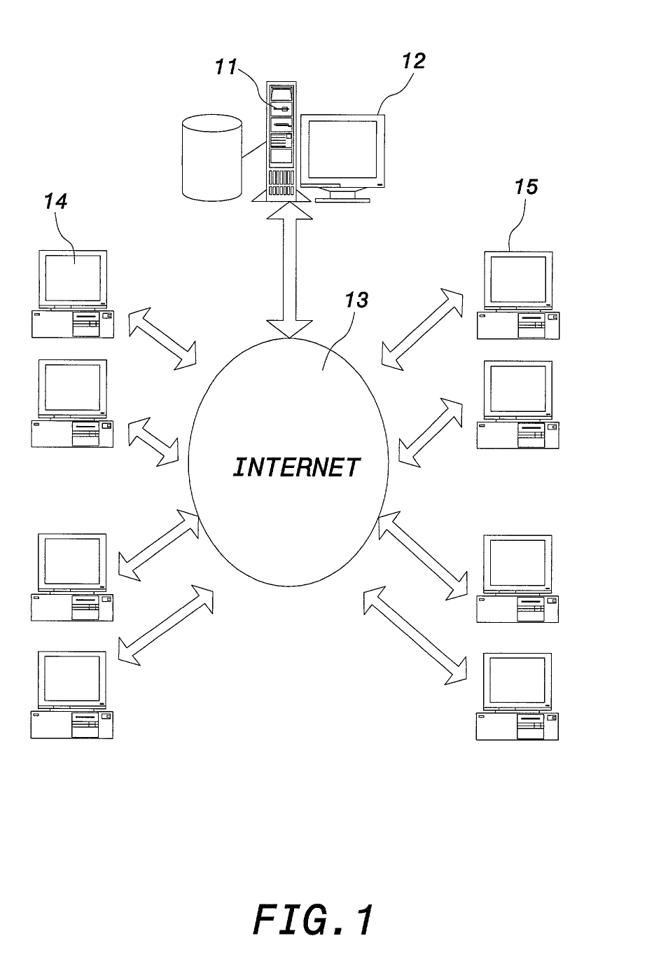

FIG. 1 shows the schematic diagram of the present invention for dealing commerce in Internet. The present invention provides a business Web site 12 in the computer server 11 of the company using the trading system of the present invention. The company using the trading system of the present invention can deal commerce with a provider 14 or a customer 15 through the Internet 13. Moreover, any provider 14 or customer 15 can also access the business Web site 12 through the Internet 13 for trading. The business Web site 12 according to the present invention can be established by the HTML, JAVA script, SQL and JSP and using the technologies of distributed structure, object-oriented skill and interactive user interface. The computer hardware used in the present invention comprises computer, modem, xDSL modem, cable modem, and leased line. The software used in the present invention includes web browser and e-mail software.

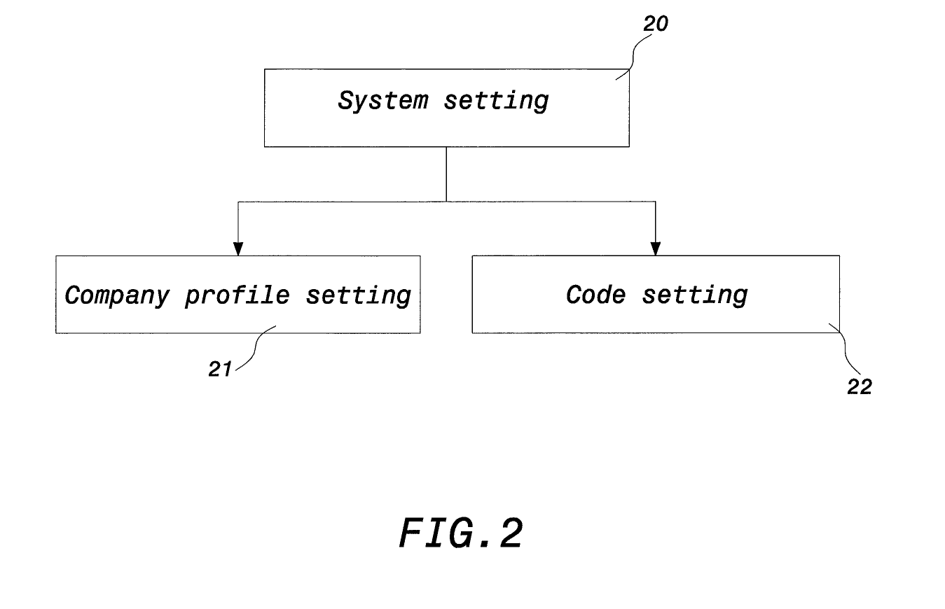

FIG. 2 shows the functional block of the system setting 20 for the business Web site 12 of the present invention. The system setting 20 comprises a company profile setting 21 and a code setting 22 to provide company and product information, and trade terms such that the engineer can easily update and maintain those data.

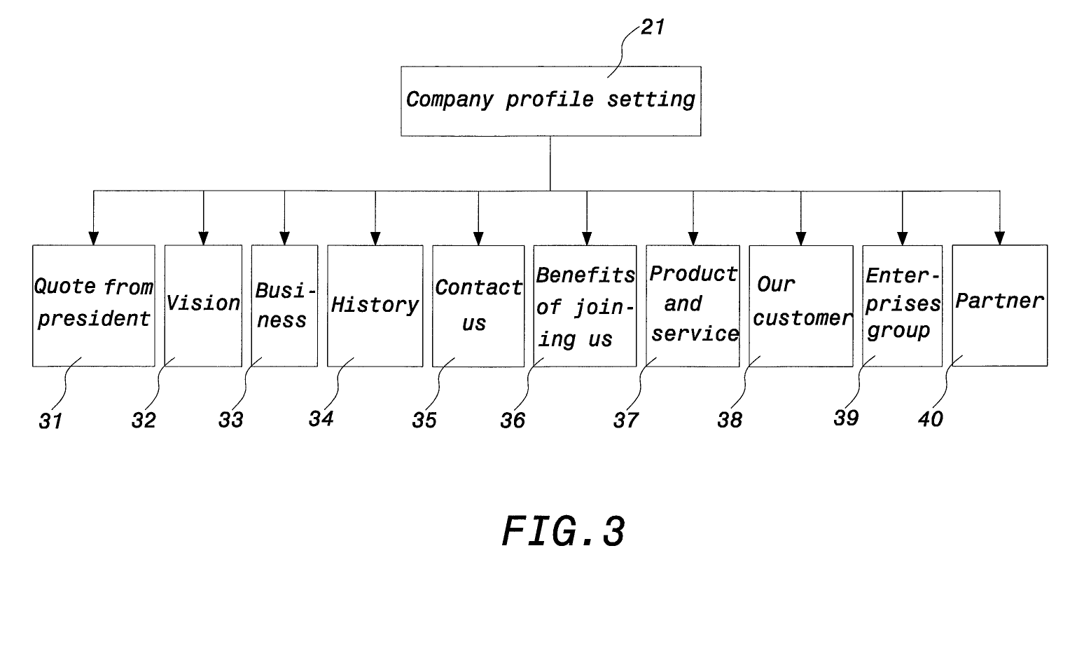

FIG. 3 shows the block diagram of the company profile setting 21. The company profile setting 21 comprises following elements: quote from president 31; vision 32; business 33; history 34; contact us 35; benefits of joining us 36; product and service 37; our customer 38; enterprises group 39 and partners 40. Those elements enable the customer to know more information about this company and facilitate the engineer to maintainer the pages.

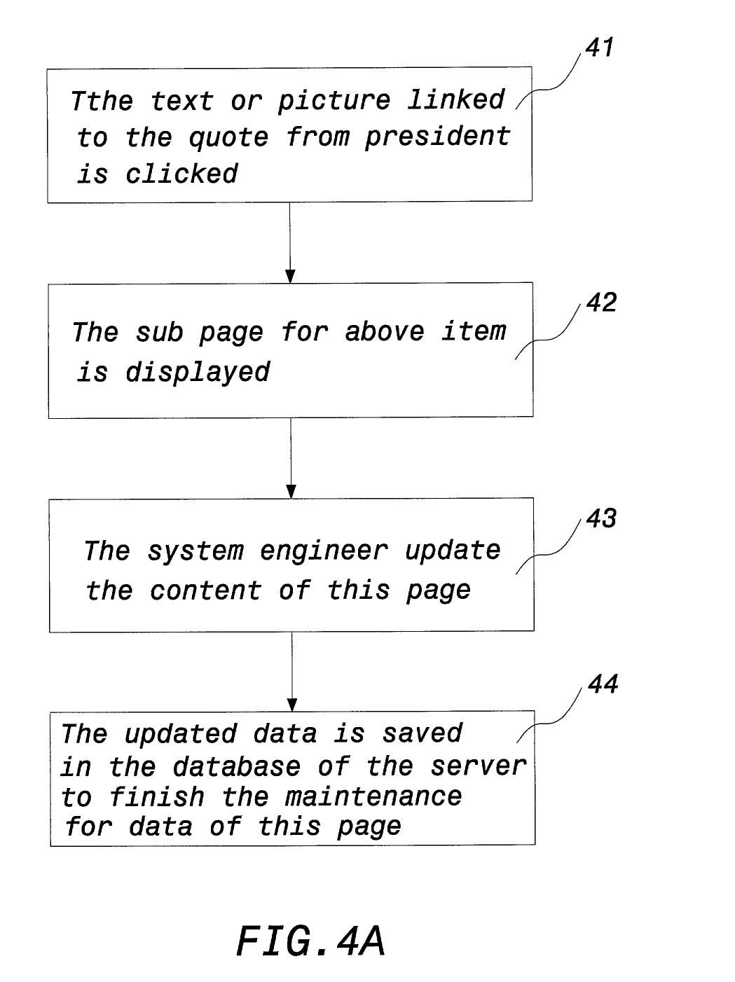

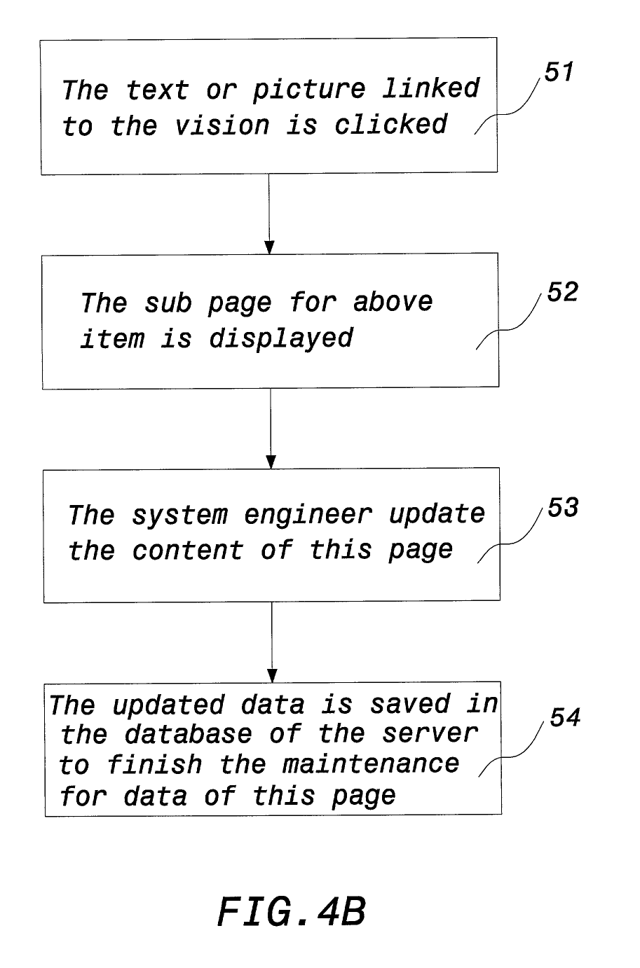

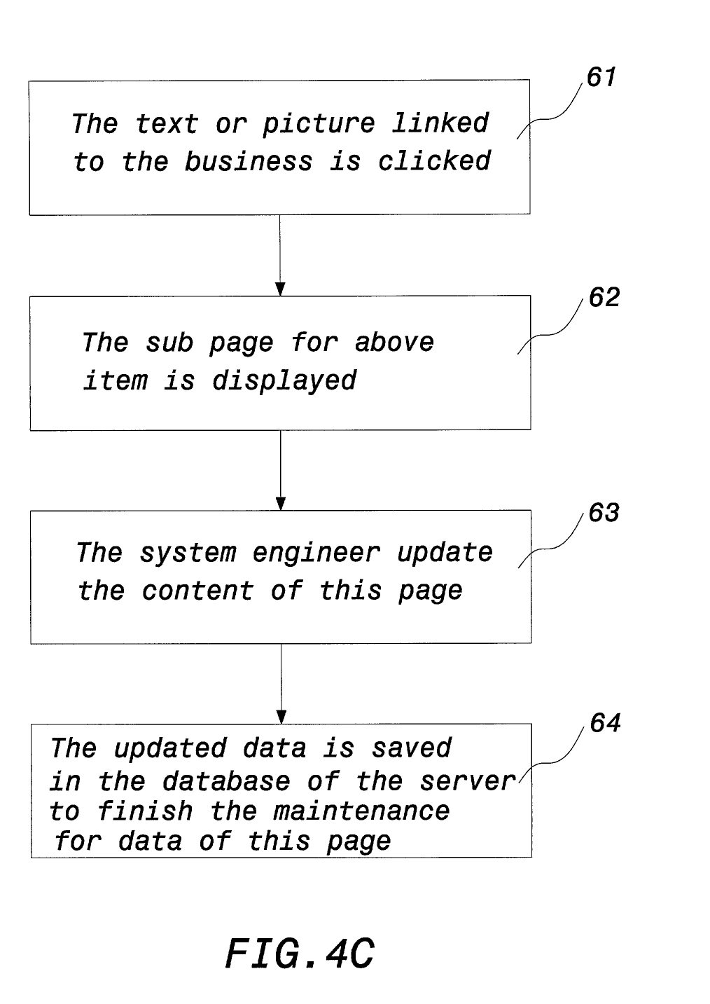

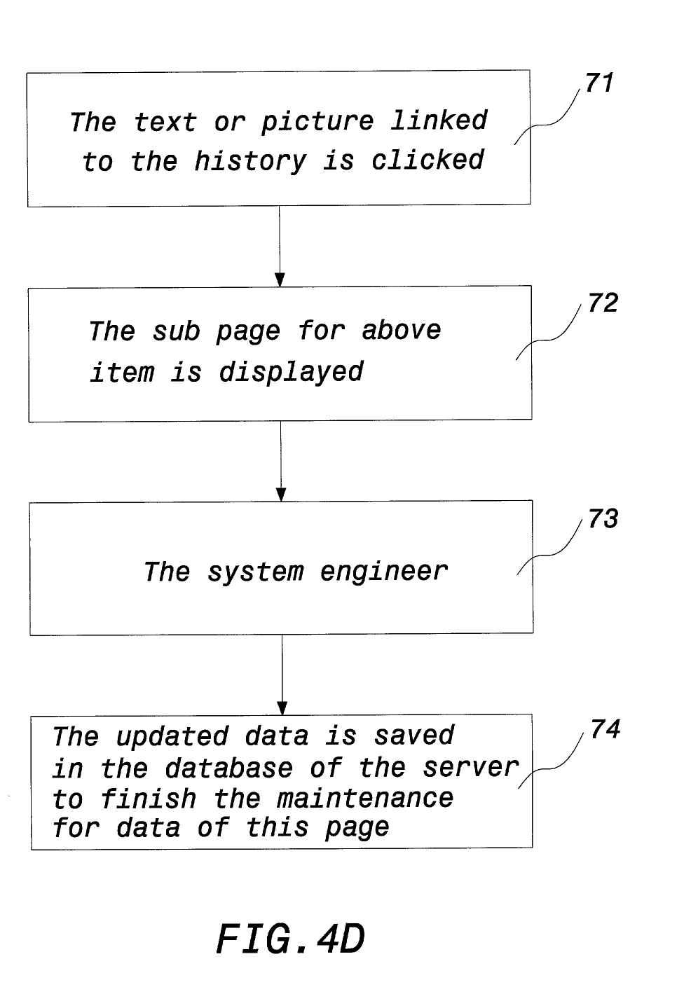

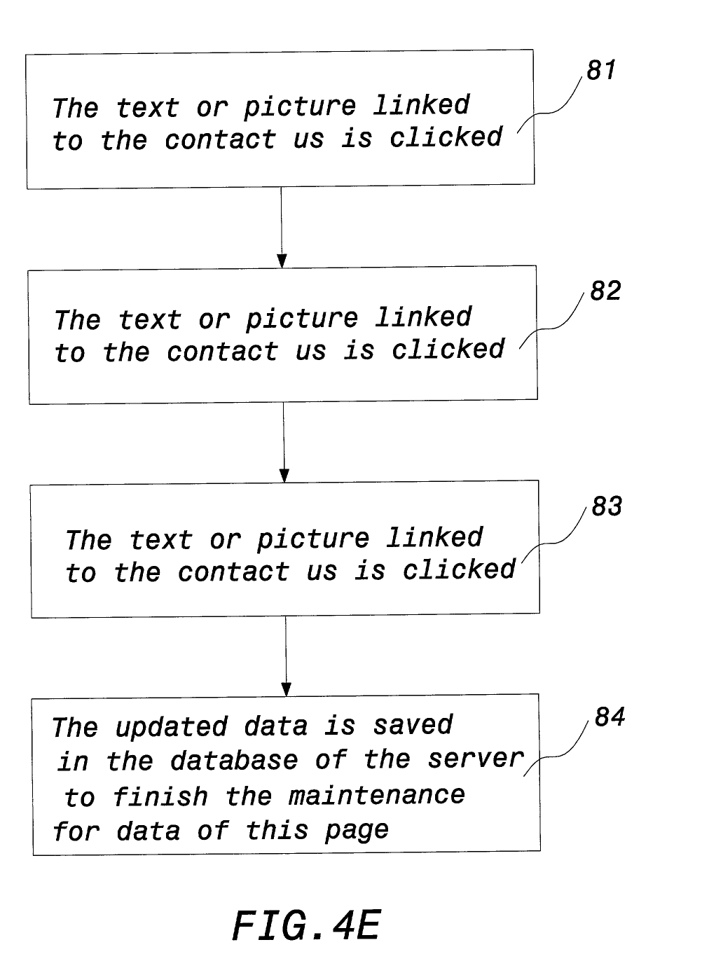

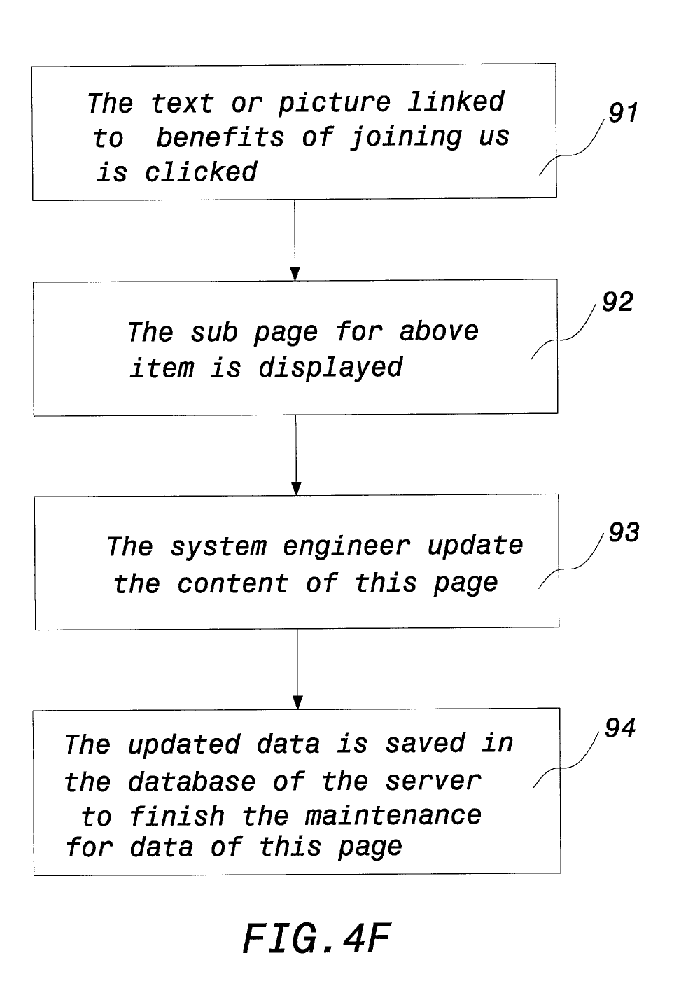

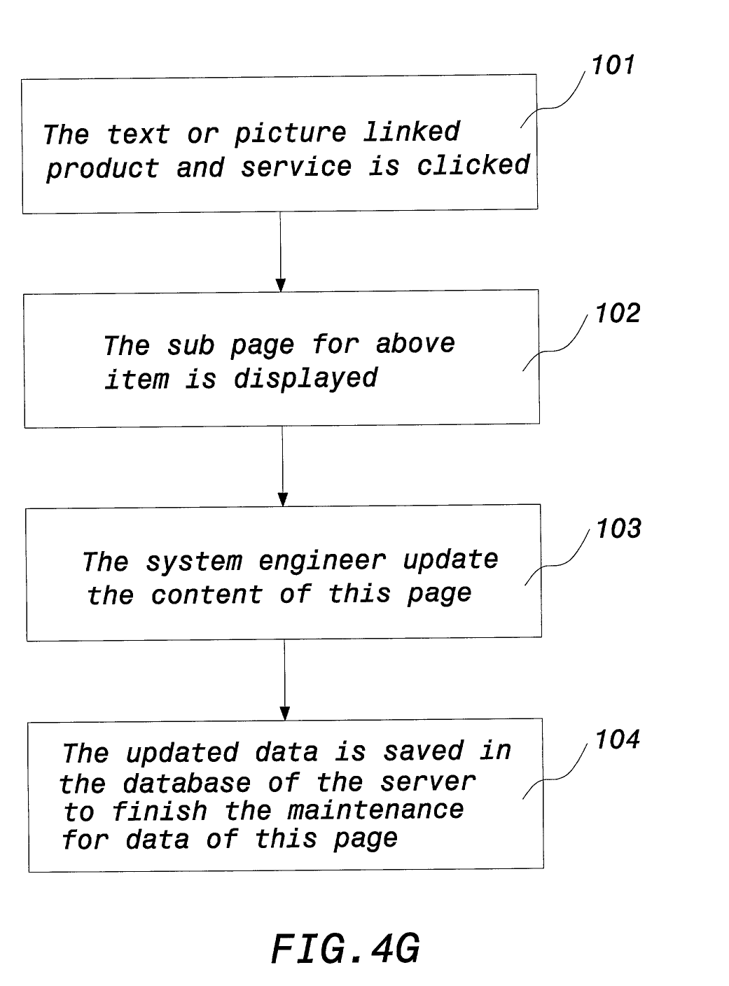

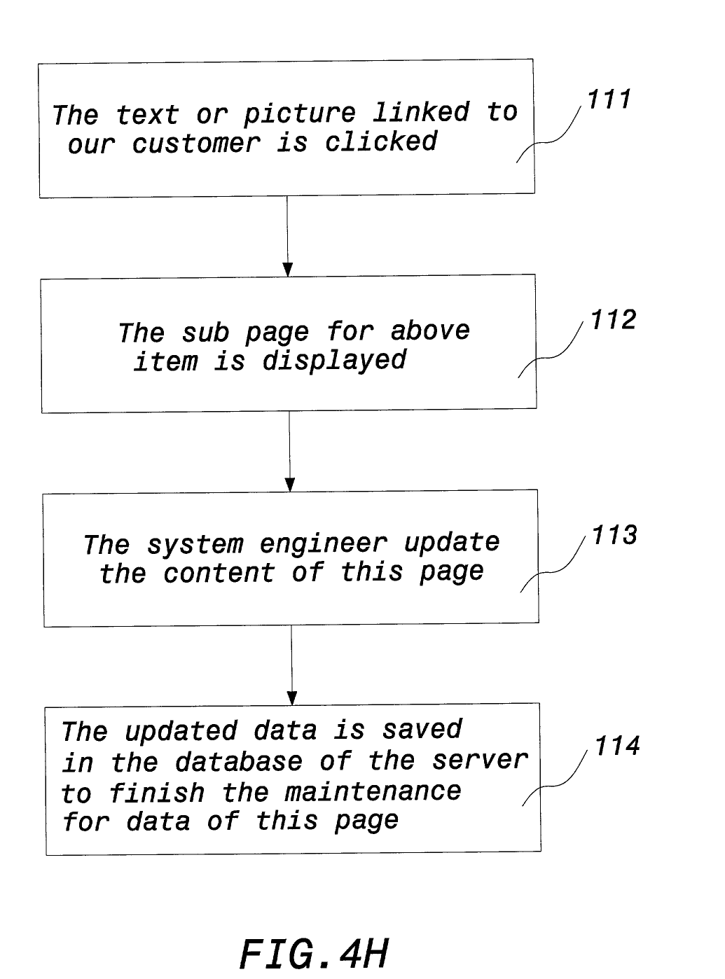

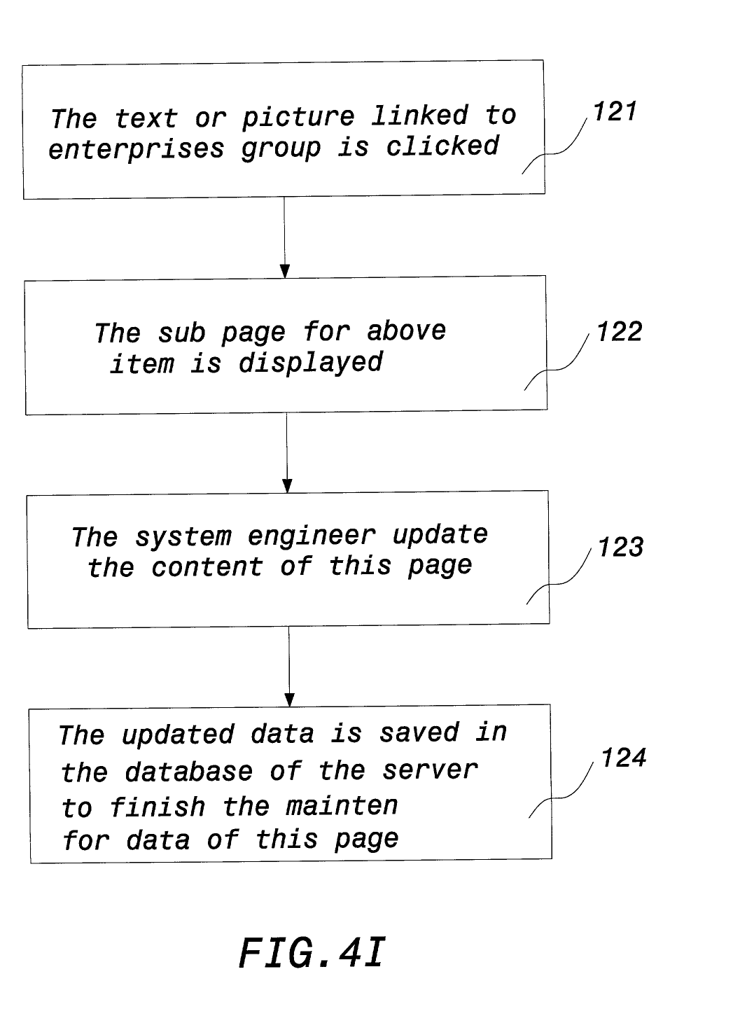

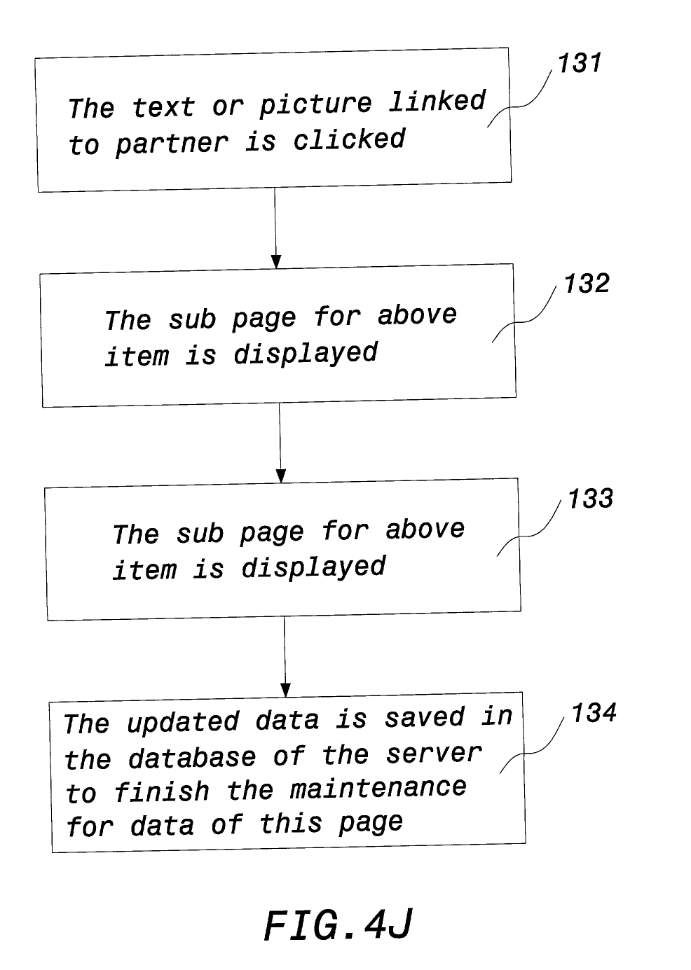

FIG. 4A shows the flowchart for maintaining the page of the quote from president 31. In step 41, the text or picture linked to the quote from president 31 is clicked and the sub page for the quote from president 31 is displayed in step 42, wherein the sub page of the quote from president 31 comprises the greeting word or manage idea of the president for the user (including company faculty, customer or suppliers) clicking the page. The system engineer can update the content of this page in step 43. In step 44, the updated data is saved in the database of the server 11 to finish the maintenance for data of this page.

FIG. 4B shows the flowchart for maintaining the page of the vision 32. In step 51, the text or picture linked to the vision 32 is clicked and the sub page for the vision 32 is displayed in step 52, wherein this page contains data for the vision and future plan of this company such that the original customer can know more about this company and more new customers are attracted. The system engineer can update the content of this page in step 53. In step 54, the updated data is saved in the database of the server 11 to finish the maintenance for data of this page.

FIG. 4C shows the flowchart for maintaining the page of the business 33. In step 61, the text or picture linked to the business 33 is clicked and the sub page for the business 33 is displayed in step 62, wherein this page contains data for the business items of this company such that the user (including customer and partners) can know more about the current state and future trend of this company form the local and overseas logistics points. The system engineer can update the content of this page in step 63. In step 64, the updated data is saved in the database of the server 11 to finish the maintenance for data of this page.

FIG. 4E shows the flowchart for maintaining the page of the contact us 35. In step 81, the text or picture linked to the contact us 35 is clicked and the sub page for the contact us 35 is displayed in step 82, wherein this page contains data for the telephone number and e-mail of the service department of this company such that the user can know contact the service department of this company through telephone or e-mail. In case of updating telephone number and e-mail of the service department, the system engineer can update the content of this page in step 83. In step 84, the updated data is saved in the database of the server 11 to finish the maintenance for data of this page.

FIG. 4F shows the flowchart for maintaining the page of the benefits of joining us 36. In step 91, the text or picture linked to the benefits of joining us 36 is clicked and the sub page for the benefits of joining us 36 is displayed in step 92, wherein this page contains data for the benefits for partners of this company to gain more partners. The system engineer can update the content of this page in step 93. In step 94, the updated data is saved in the database of the server 11 to finish the maintenance for data of this page.

FIG. 4G shows the flowchart for maintaining the page of the product and service 37. In step 101, the text or picture linked to the product and service 37 is clicked and the sub page for the product and service 37 is displayed in step 102, wherein this page contains important data for B2B (business to business) and B2C (business to customer) commerce. The page lists the product produced, manufactured or designed by the company or the products of the partners. The page also contains the data for on-line trade and procedures. The system engineer can update the content of this page in step 103 to display above data in the Web site 12. In step 104, the updated data is saved in the database of the server 11 to finish the maintenance for data of this page.

FIG. 4H shows the flowchart for maintaining the page of our customer 38. In step 111, the text or picture linked to our customer 38 is clicked and the sub page for our customer 38 is displayed in step 112, wherein this page contains data for the names of registered customers to attract more customers. The system engineer can update the content of this page in step 113. In step 114, the updated data is saved in the database of the server 11 to finish the maintenance for data of this page.

FIG. 4I shows the flowchart for maintaining the page of enterprises group 39. In step 121, the text or picture linked to enterprises group 39 is clicked and the sub page for enterprises group 39 is displayed in step 122, wherein this page contains data for the data, current state and web links of other enterprises group of this company such that the user (including customer and partners) can know more about the enterprises group of this company. The system engineer can update the content of this page in step 123. In step 124, the updated data is saved in the database of the server 11 to finish the maintenance for data of this page.

FIG. 4J shows the flowchart for maintaining the page of partners 40. In step 131, the text or picture linked to partners 40, is clicked and the sub page for partners 40, is displayed in step 132, wherein this page contains data for the partners of this company such that the user (including customer and partners) can know more about the partners cooperated with this company. The system engineer can update the content of this page in step 133. In step 134, the updated data is saved in the database of the server 11 to finish the maintenance for data of this page.

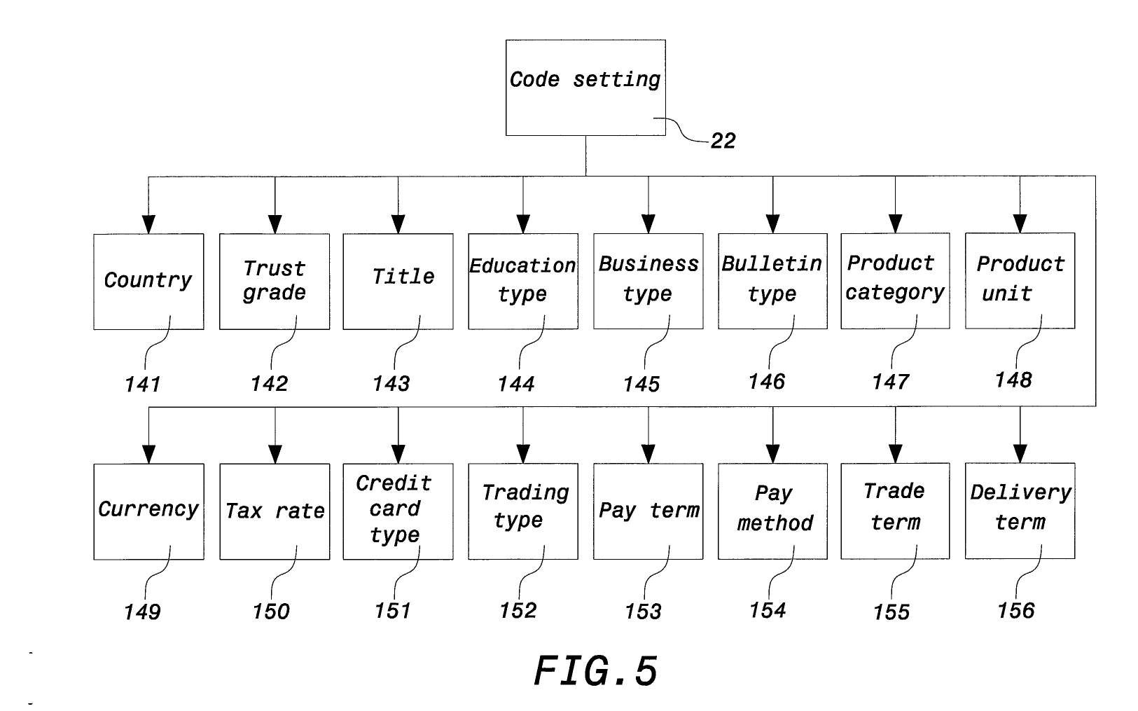

FIG. 5 shows the block diagram of the code setting 22. The codes comprises country 141, trust grade 142, title 143, education type 144, business type 145, bulletin type 146, product category 147, product unit 148, currency 149, tax rate 150, credit card type 151, trading type 152, pay term 153, pay method 154, trade term 155, and delivery term 156.

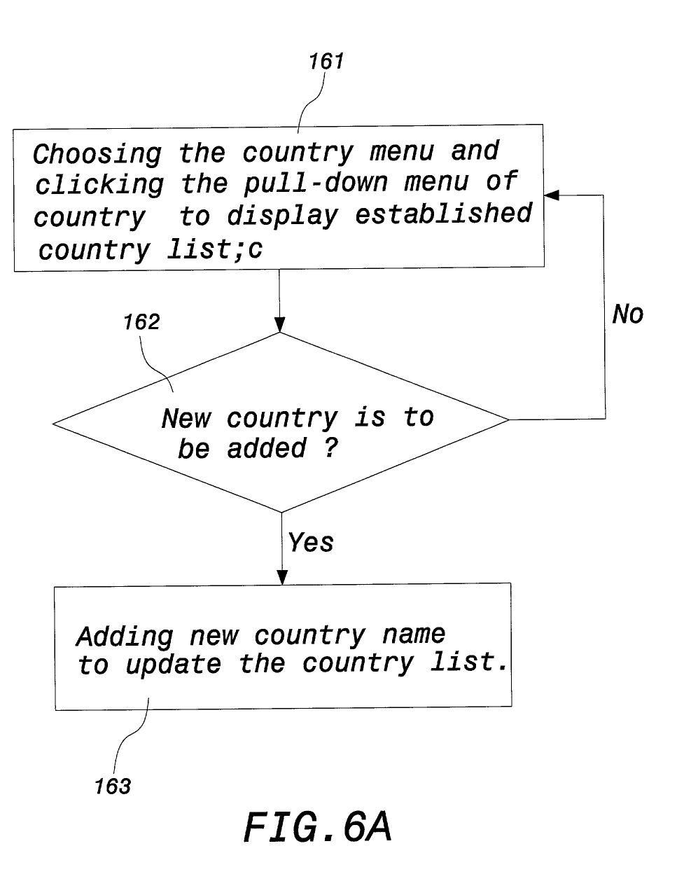

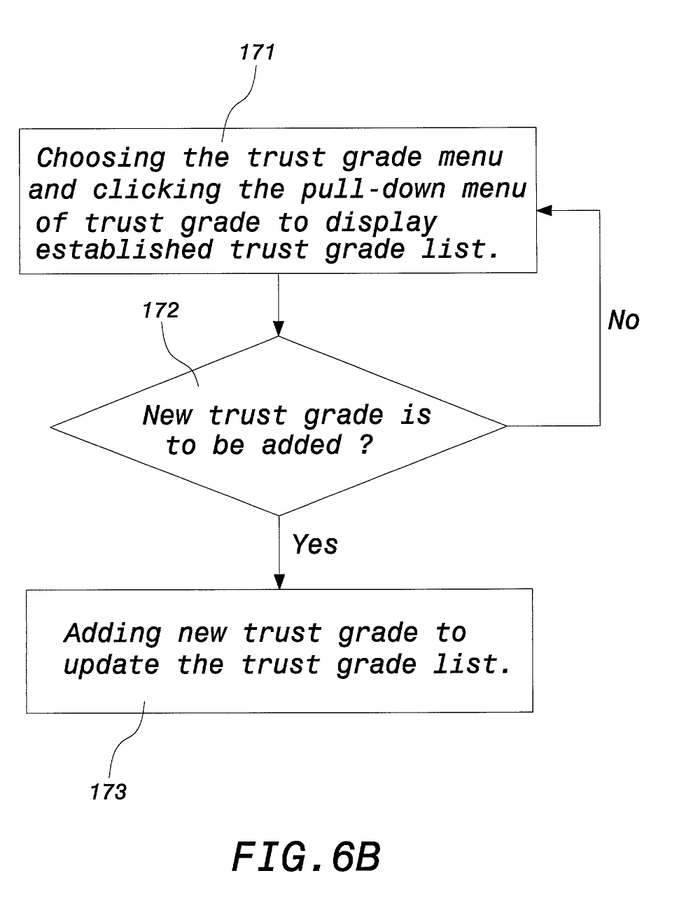

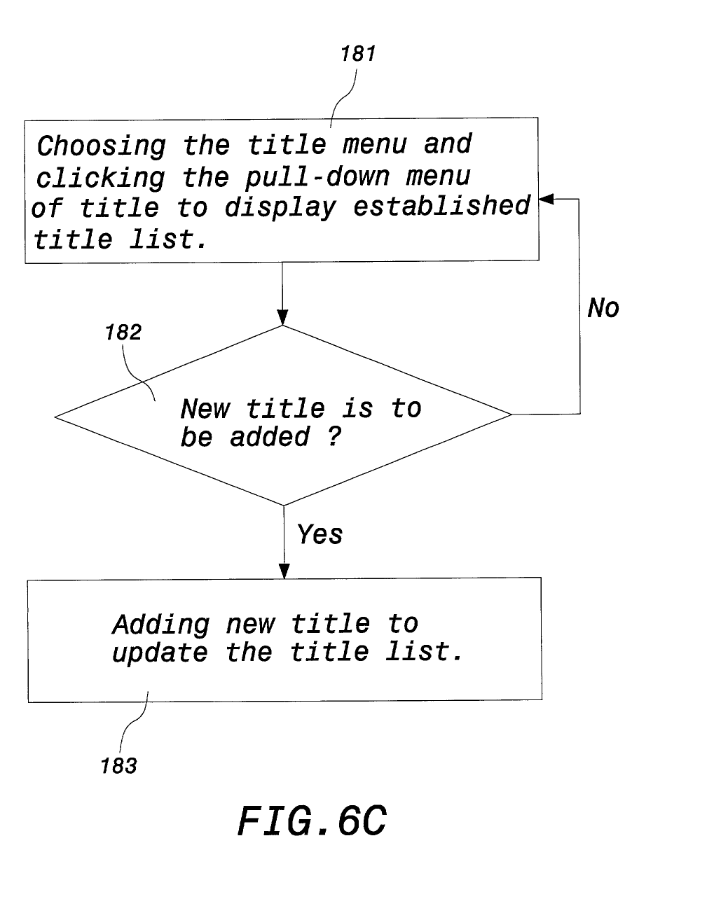

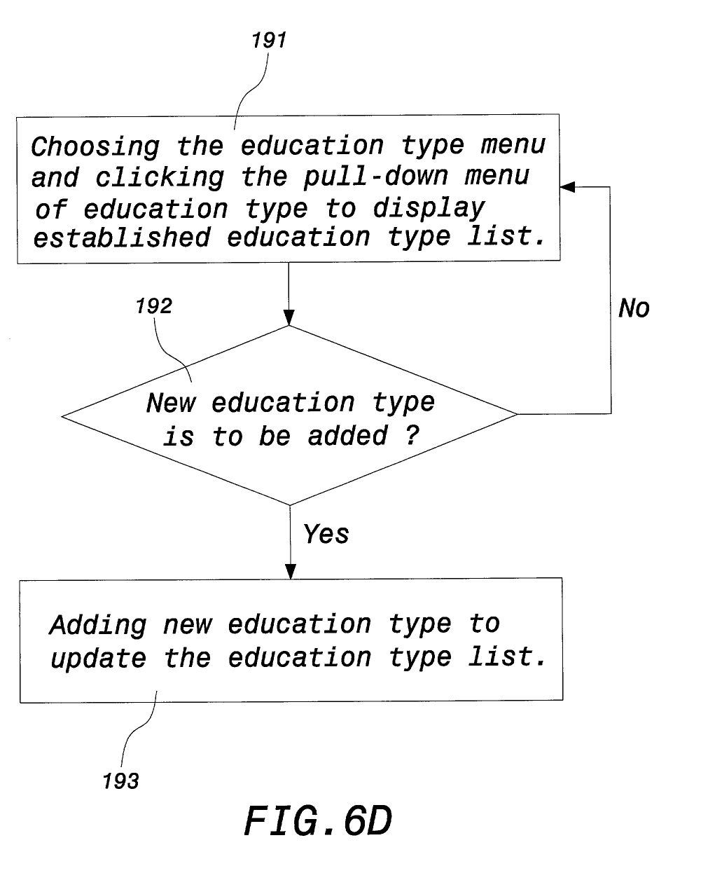

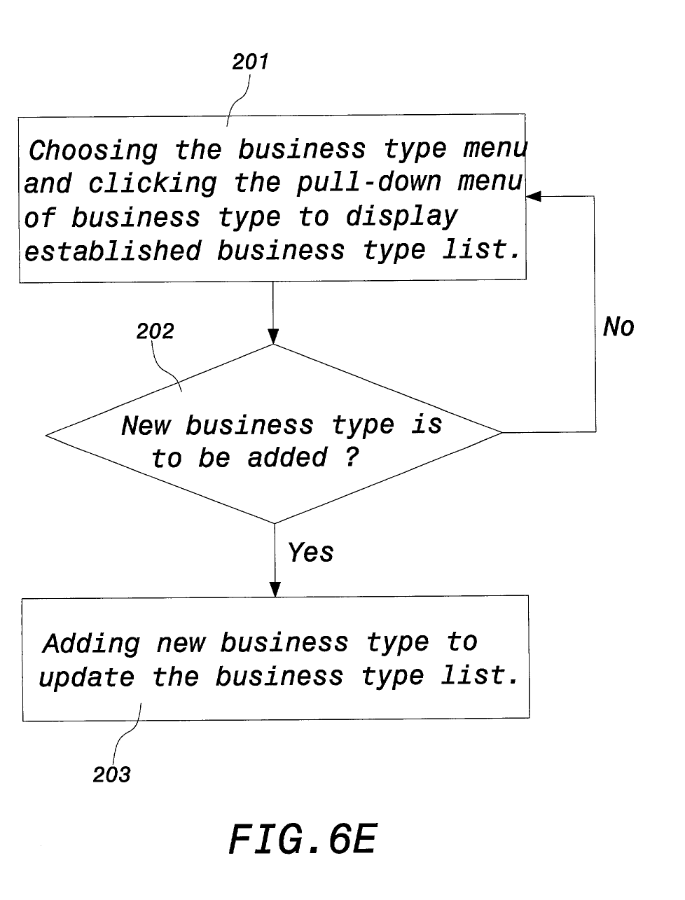

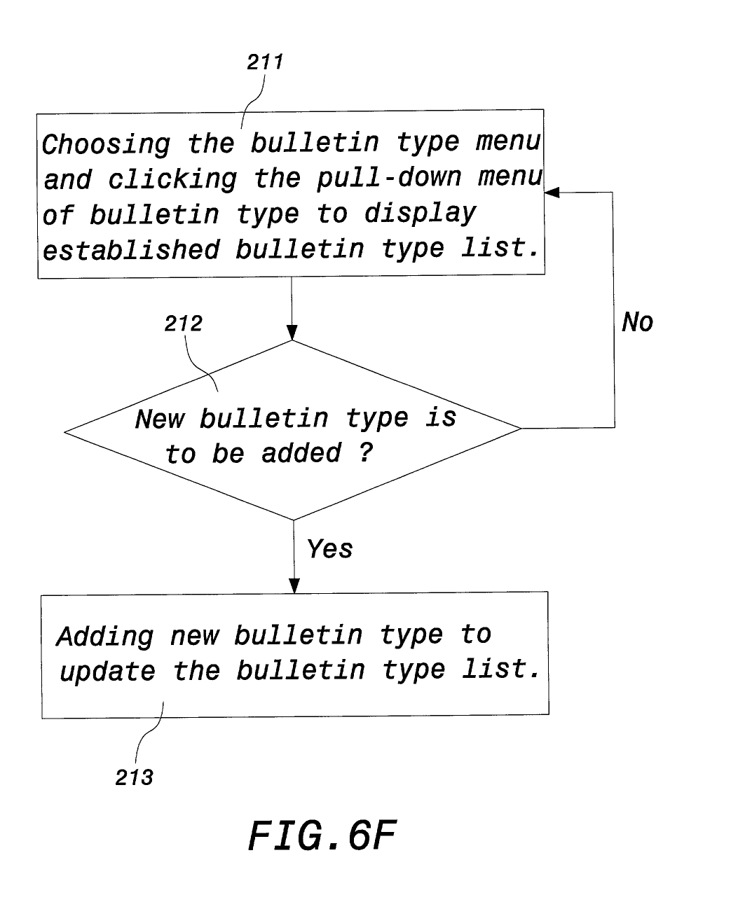

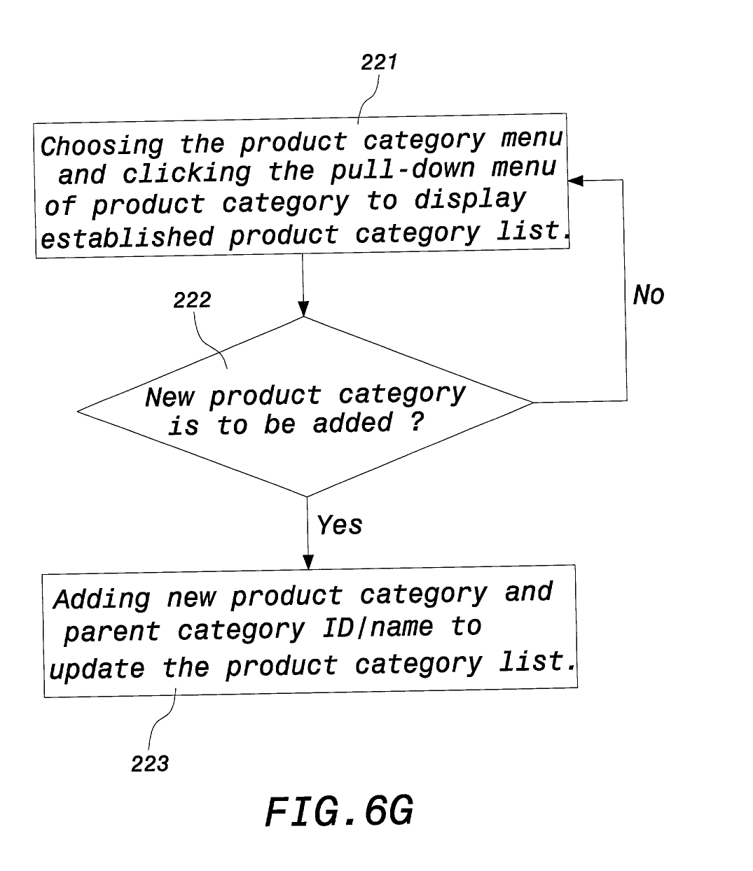

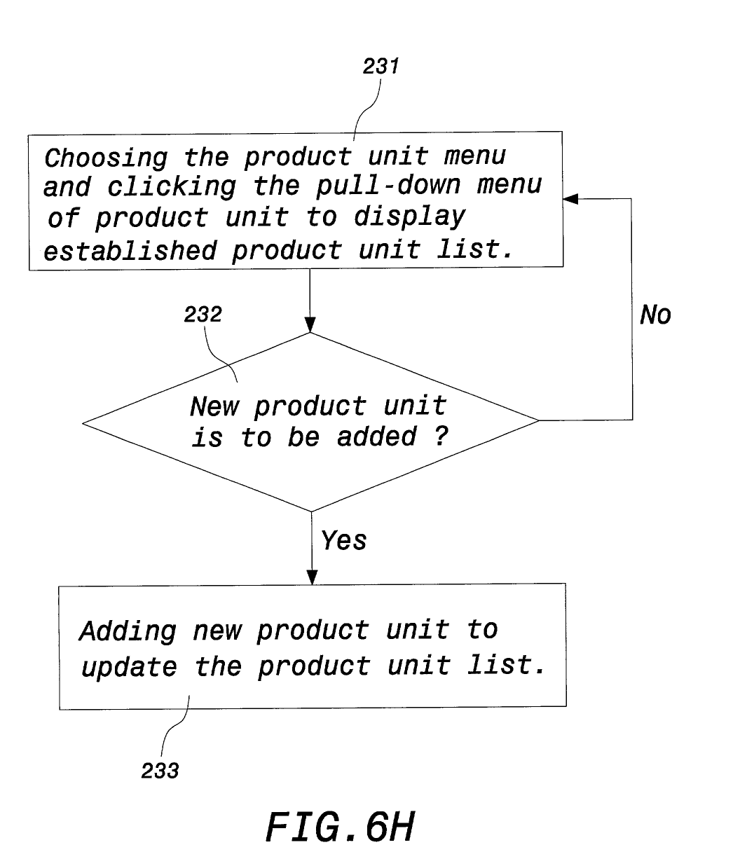

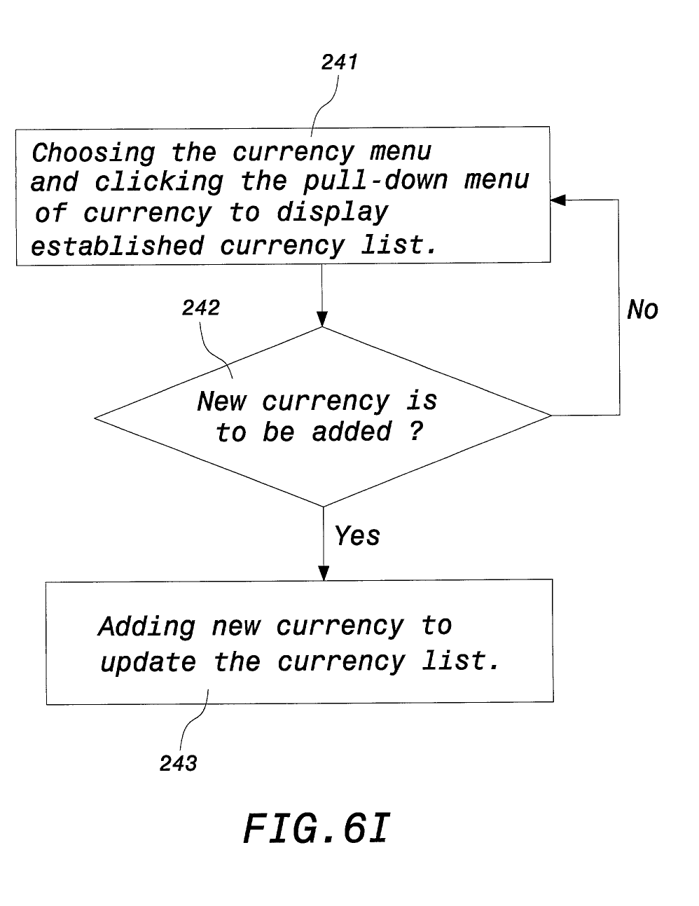

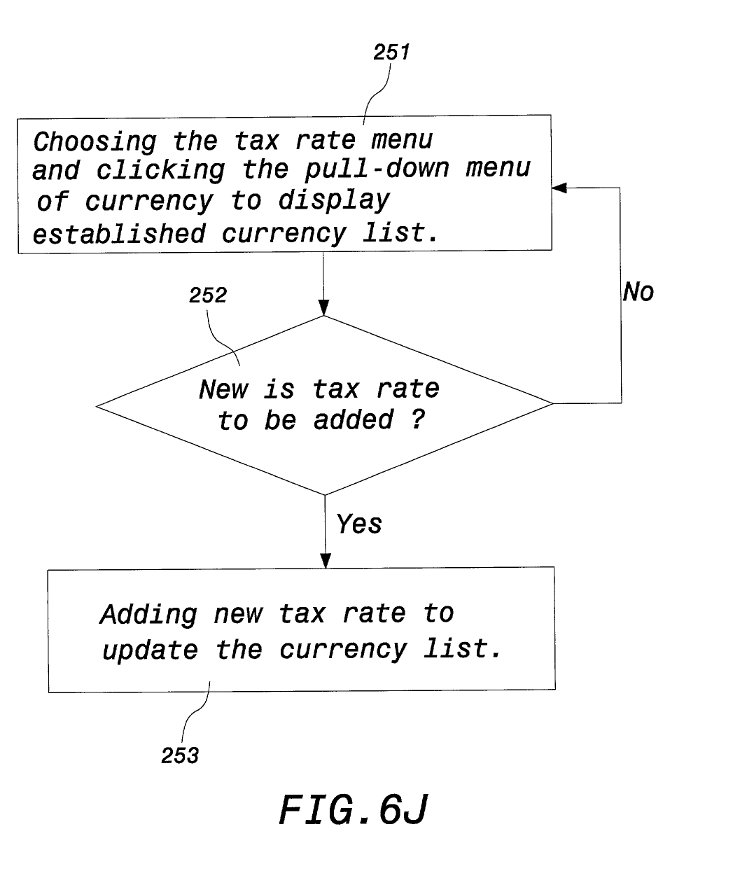

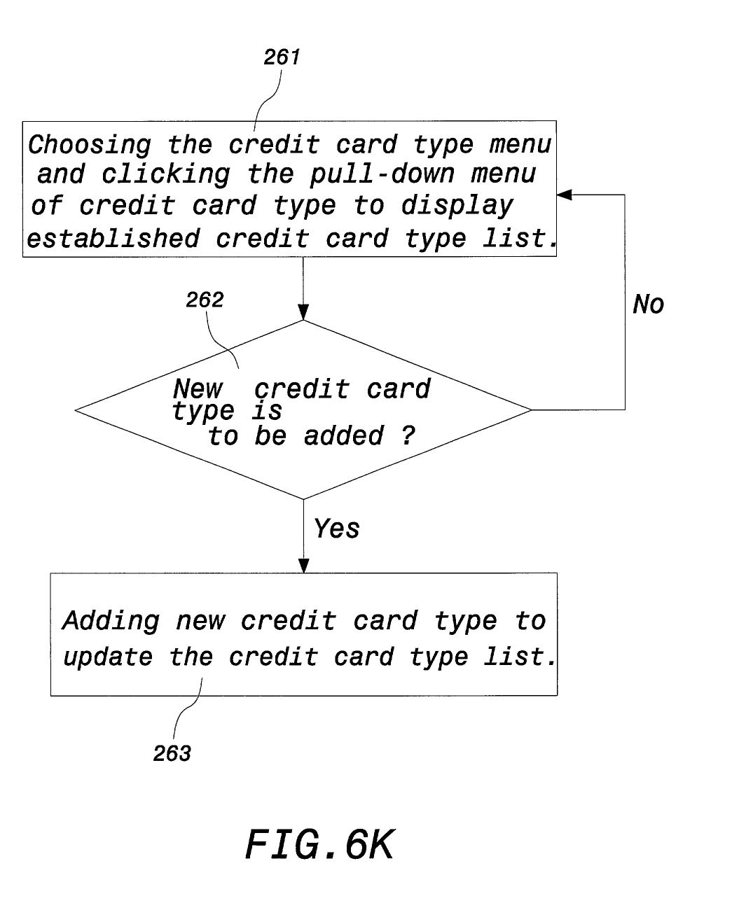

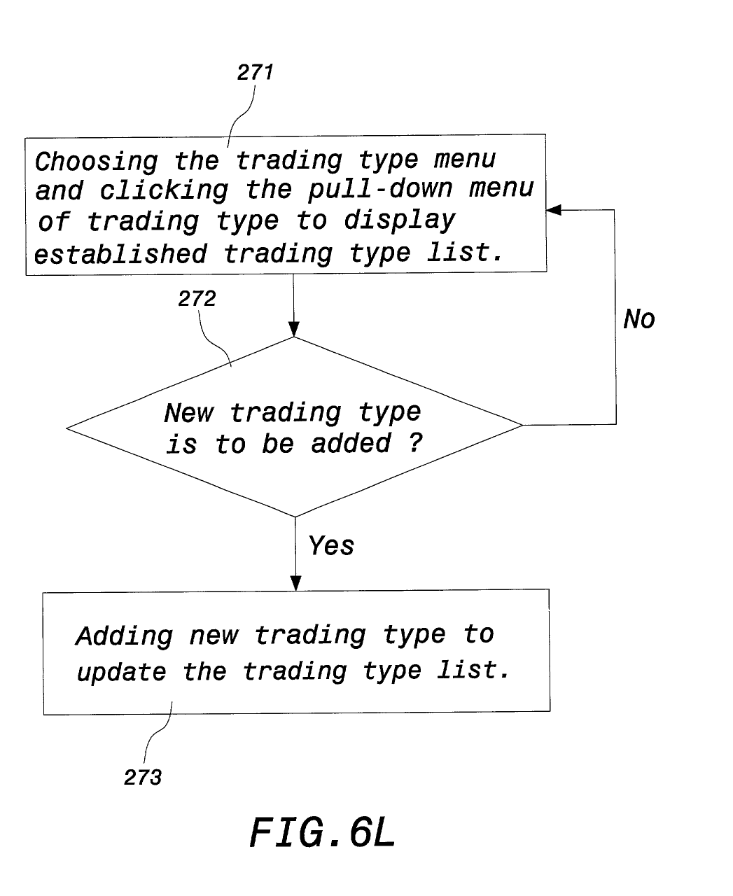

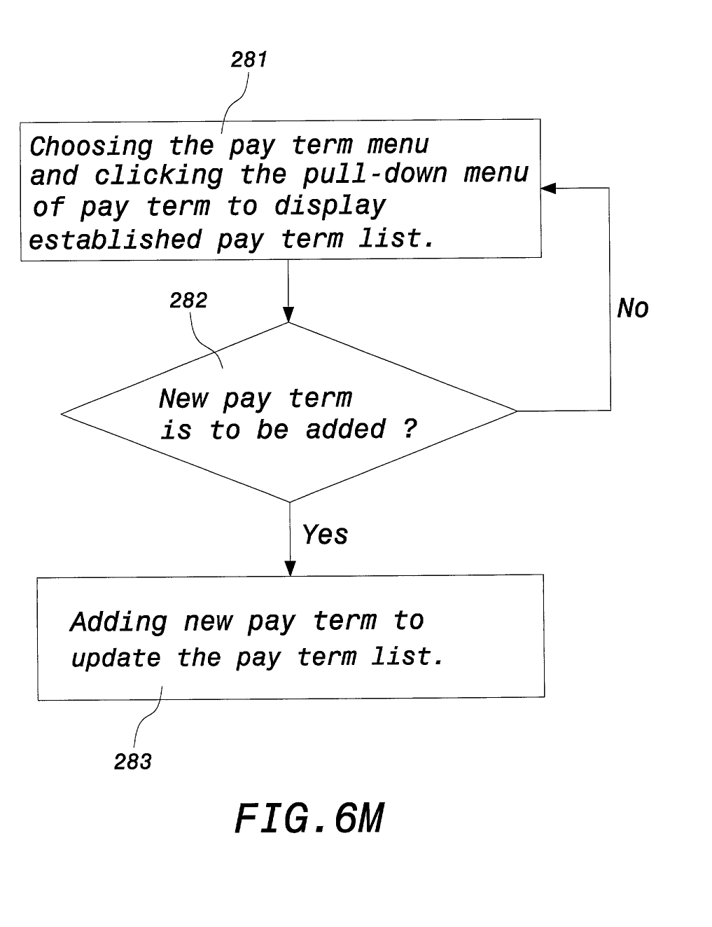

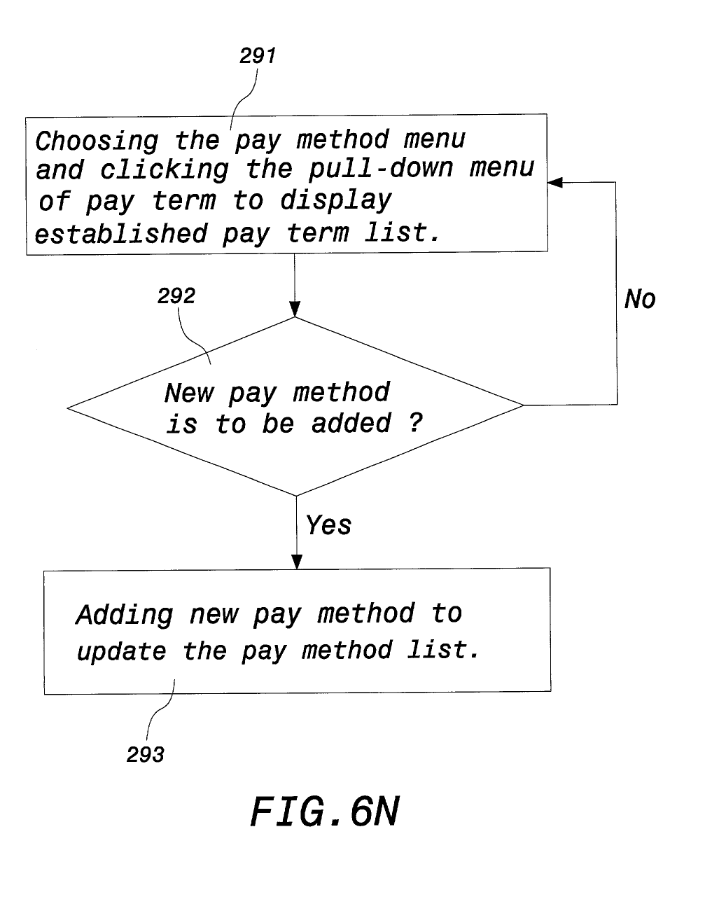

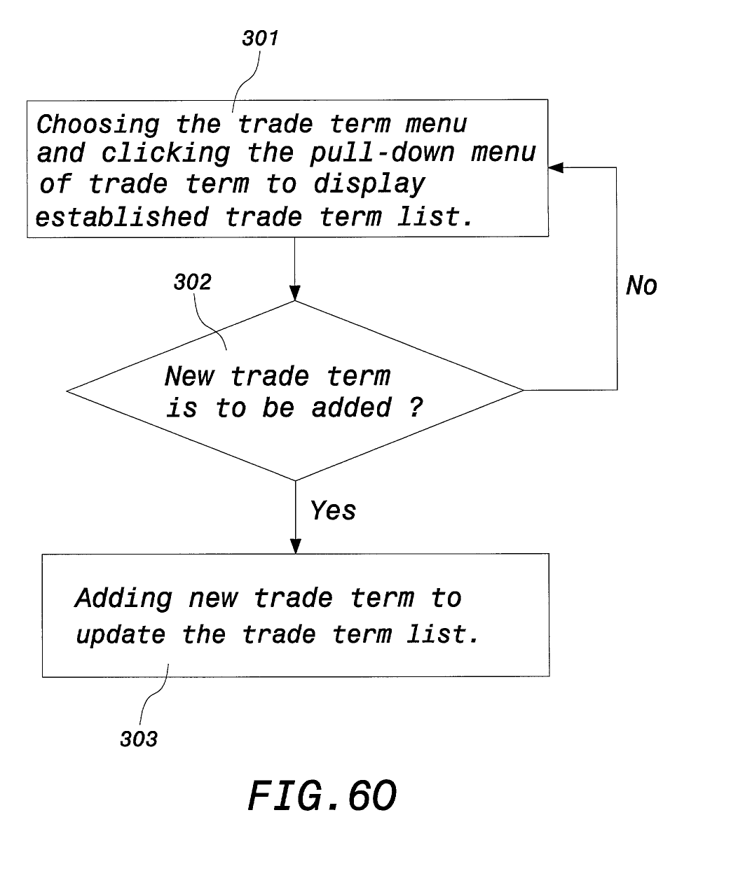

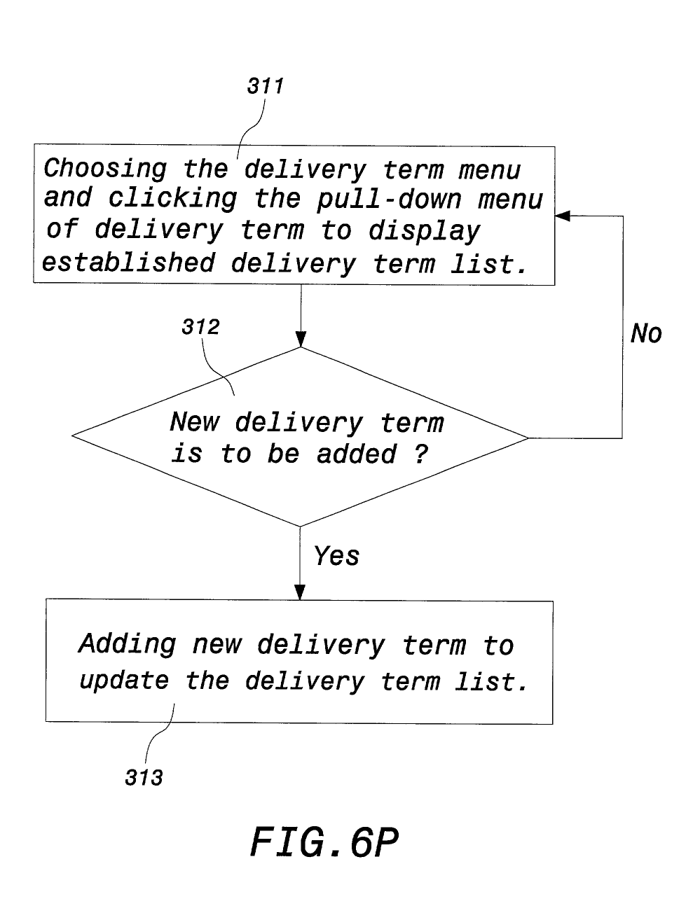

FIG. 6A shows the flowchart for setting the country, which comprises following steps:

Step 161: choosing the country menu and clicking the pull-down menu of country to display established country list;

Step 162: if no new country is to be added, return to step 161;

Step 163: adding new country name to update the country list.

FIG. 6B shows the flowchart for setting the trust grade, which comprises following steps:

Step 171: choosing the trust grade menu and clicking the pull-down menu of trust grade to display established trust grade list;

Step 172: if no new trust grade is to be added, return to step 171;

Step 173: adding new trust grade to update the trust grade list.

FIG. 6C shows the flowchart for setting the title, which comprises following steps:

Step 181: choosing the title menu and clicking the pull-down menu of title to display established title list;

Step 182: if no new title is to be added, return to step 181;

Step 183: adding new title to update the title list.

FIG. 6D shows the flowchart for setting the education type, which comprises following steps:

Step 191: choosing the education type menu and clicking the pull-down menu of education type to display established education type list;

Step 192: if no new education type is to be added, return to step 191;

Step 193: adding new education type to update the education type list.

FIG. 6E shows the flowchart for setting the business type, which comprises following steps:

Step 201: choosing the business type menu and clicking the pull-down menu of business type to display established business type list;

Step 202: if no new business type is to be added, return to step 201;

Step 203: adding new business type to update the business type list.

FIG. 6F shows the flowchart for setting the bulletin type, which comprises following steps:

Step 211: choosing the bulletin type menu and clicking the pull-down menu of bulletin type to display established bulletin type list;

Step 212: if no new bulletin type is to be added, return to step 211;

Step 213: adding new bulletin type to update the bulletin type list.

FIG. 6G shows the flowchart for setting the product category, which comprises following steps:

Step 221: choosing the product category menu and clicking the pull-down menu of product category to display established product category list;

Step 222: if no new product category is to be added, return to step 221;

Step 223: adding new product category and parent category ID/name to update the product category list.

FIG. 6H shows the flowchart for setting the product unit, which comprises following steps:

Step 231: choosing the product unit menu and clicking the pull-down menu of product unit to display established product unit list;

Step 232: if no new product unit is to be added, return to step 231;

Step 233: adding new product unit to update the product unit list.

FIG. 6I shows the flowchart for setting the currency, which comprises following steps:

Step 241: choosing the currency menu and clicking the pull-down menu of currency to display established currency list;

Step 242: if no new currency is to be added, return to step 241;

Step 243: adding new currency to update the currency list.

FIG. 6J shows the flowchart for setting the currency, which comprises following steps:

Step 251: choosing the tax rate menu and clicking the pull-down menu of tax rate to display established currency list;

Step 252: if no new tax rate is to be added, return to step 25 1;

Step 253: adding new tax rate to update the tax rate list.

FIG. 6K shows the flowchart for setting the credit card type, which comprises following steps:

Step 261: choosing the credit card type menu and clicking the pull-down menu of credit card type to display established credit card type list;

Step 262: if no new credit card type is to be added, return to step 261;

Step 263: adding new credit card type to update the credit card type list.

FIG. 6L shows the flowchart for setting the trading type, which comprises following steps:

Step 271: choosing the trading type menu and clicking the pull-down menu of trading type to display established trading type list;

Step 272: if no new trading type is to be added, return to step 271;

Step 273: adding new trading type to update the trading type list.

FIG. 6M shows the flowchart for setting the pay term, which comprises following steps:

Step 281: choosing the pay term menu and clicking the pull-down menu of pay term to display established pay term list;

Step 282: if no new pay term is to be added, return to step 281;

Step 283: adding new pay term to update the pay term list.

FIG. 6N shows the flowchart for setting the pay method, which comprises following steps:

Step 291: choosing the pay method menu and clicking the pull-down menu of pay method to display established pay method list;

Step 292: if no new pay method is to be added, return to step 291;

Step 293: adding new pay method to update the pay method list.

FIG. 6O shows the flowchart for setting the trade term, which comprises following steps:

Step 301: choosing the trade term menu and clicking the pull-down menu of trade term to display established trade term list;

Step 302: if no new trade term is to be added, return to step 301;

Step 303: adding new trade term to update the trade term list.

FIG. 6P shows the flowchart for setting the delivery term, which comprises following steps:

Step 311: choosing the delivery term menu and clicking the pull-down menu of delivery term to display established delivery term list;

Step 312: if no new delivery term is to be added, return to step 311;

Step 313: adding new delivery term to update the delivery term list.

The method for setting on-line commerce Web site according to the present invention has following features:

(1) By setting the company profile, the on-line user has newest information of company state and products.

(2) By setting the code, the customer can choose desired item from menu and it helps the system engineer to update the menu items.

Although the present invention has been described with reference to the preferred embodiment thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

I claim

1. A method for setting on-line commerce Web site, wherein a business Web site is set up in a computer server of a company using the method, the company using the Web site to deal commerce with a provider or a customer through Internet; the Web site being easily maintained by a system engineer, the method comprising
setting a company profile, which contains brief data of the company to facilitate the contact and service to the customer and provider and attract new customer and provider; the company profile being maintained by the system engineer;
setting a code corresponding to trade-related items provided by the Web site; the code being updated, renewed and maintained by the system engineer.

2. The method for setting on-line commerce Web site as in claim 1, wherein the company profile setting comprises the following units: quote from president; vision; business; history; contact us; benefits of joining us; product and service; our customer; enterprises group and partners.

3. The method for setting on-line commerce Web site as in claim 2, wherein the system engineer can clicked text or picture linked to each of above units and enter the sub page containing the unit; the system engineer updating and saving the updated data to database of the computer server.

4. The method for setting on-line commerce Web site as in claim 1, wherein the code setting comprises the following units: country, trust grade, title, education type, business type, bulletin type, product category, product unit, currency, tax rate, credit card type, trading type, pay term, pay method, trade term, and delivery term.

5. The method for setting on-line commerce Web site as in claim 4, wherein the procedure for updating each code setting comprises following steps:
choosing an menu for the code setting and clicking the pull-down menu of the code to display established code list;
if new bulletin type is to be added, adding new code to update the code list.
